(19) United States
(12) Patent Application Publication
(10) Pub. No.: US 2015/0086704 A1
(43) Pub. Date: Mar. 26, 2015

(54) Coating Spray System

(71) Applicant: Keystone Dental Group, Cherry Hill, NJ (US)

(72) Inventors: James R. Vinson, Clarksville, TN (US); Phillip G. Pitts, Franklin, TN (US)

(21) Appl. No.: 14/398,089

(22) PCT Filed: Apr. 30, 2013
(86) PCT No.: PCT/US2013/038892

§ 371 Date: Oct. 30, 2014

Related U.S. Application Data
(60) Provisional application No. 61/640,567, filed on Apr. 30, 2012.

(51) Int. Cl. B05B 9/03; B05B 11/00

(52) U.S. Cl. CPC B05B 9/03; B05B 11/0037
USPC 427/2.26; 106/35; 239/337

(57) ABSTRACT

Embodiments of the present invention include a spray bonder that comprises a bonder, a carrier, and, optionally, a propellant. Embodiments also include a coating spray system that comprises the spray bonder and a coating spray that includes a coating material, a carrier, and, optionally, a propellant. The coating material can be an opaque material, glass fit, opacious dentin, or the like. Also provided are methods for using the spray bonder and/or coating spray to coating objects, such as coating dental implants to match the color of a patient's gums.

### RELATED APPLICATIONS

This application claims priority from U.S. Provisional Application Ser. No. 61/640,567, filed Apr. 30, 2012, the entire disclosure of which is incorporated herein by this reference.

### TECHNICAL FIELD

The present invention generally relates to system for coating objects with a coating material, and more particularly to a coating spray system that can coat dental implants. The present invention also relates to a spray bonder that, optionally, can be used in conjunction with the coating spray to coat an object. The present invention also relates to methods of coating and coloring an item, such as a dental implant.

### BACKGROUND OF THE INVENTION

Dentists have used implants for years to replace missing or damaged teeth. A majority of implants that are used today are root-form endosseous implants. These implants have a root end portion that acts as a tooth root and extends into a patient's bone. In successful implants, the root end of an implant osseointegrates (e.g., fuses) with the bone. Implants further comprise a dental prosthesis on the end opposing the root end. The dental prosthesis can include a crown, an implant-supported bridge, a denture, or the like. Implants further comprise an abutment located between the root end and the dental prosthesis. This abutment is typically found within the gums, and attaches the root end that is embedded in bone to a dental prosthesis that is positioned on or near the surface of the gums.

Dental implants are typically made of titanium, but may also be manufactured from chrome cobalt, zirconia, rubidium, and the like. A problem with current dental implants is that the material of the implant usually does not match the pigment of the gums. In these situations the abutment of the implant, which is located within the gums, may be visible. For example, titanium dental implants can appear as a dark color or a shadow on patients' gums.

This coloration issue has not been solved, in part because titanium implants are generally made of commercially pure titanium that porcelain does not adhere to well. For other titanium products, such as titanium copings, it is known that one may first brush a titanium bonder on an implant and fire the implant before brushing an opaque substance on the implant and once again firing the implant. The application and firing of a bonder modifies the implant surface so that an opaque or porcelain adheres to the titanium implant. This two-step process produces surfaces that are generally uneven. In fact, such bonder and opaque techniques have not been used for dental implants, in part because dental implants must fit tight spaces, have small tolerances, and abut bone, gums, and teeth.

This known method of using a brush-on bonder and opaque is also time consuming, requires highly-skilled technicians, and has the potential to produce uneven coatings that are prone to breakage or adversely affect the fit of an implant. This is because, among other things, the bonder and opaque are both powders that must be mixed with respective liquids to be applied to an object. The brushed-on bonder and opaque also have the natural tendency to settle and migrate due to gravity once they are applied to an implant. Therefore, even if a thin and even coat is applied, there is the chance that the substance will settle and form an uneven surface. Consequently, brush-on coatings rarely, if ever, achieve thicknesses as low as 0.4 to 0.6 mm that are required for titanium copings, for example.

Once applied, thick, coarse, or uneven coatings of opaque or porcelain have the tendency to crack because of thermal expansion during firing. A coating that is too thick can also lead to bubbling during firing and poor bonding from incomplete wetting of the implant surface. Furthermore, uneven coatings on objects for dental implantation have the tendency to trap plaque and other bacteria.

Accordingly, there remains a long-felt but unmet need for a coating spray system that can coat and color an object, such as a titanium implant, in a timely and cost-effective manner. There also remains a need for coating system that does not require extensive training, does not produce uneven or thick coatings, and does not unduly affect the fit, finish, or functionality of an implant.

### SUMMARY OF THE INVENTION

It is accordingly one object of the present invention to provide a coating spray system for coating and coloring objects that will overcome the above-described limitations and disadvantages of prior art. In some embodiments the coating spray system comprises a spray bonder and/or a coating spray. Embodiments of the present invention fill a need for an improved method of coating dental implants to reflect the pigment of gums.

It is another object of the present invention to provide a coating spray system that allows for a uniform layer of opaque porcelain, glaze, opacious dentin, or the like to coat and adhere to a surface of a dental implant.

Another object of the present invention is to provide a simple and dependable method for spraying coating materials, such as opaque materials, that is easy to carry out, and that allows an individual or technician with a minimal amount of experience coating procedures to apply a substantially homogeneous layer of opaque or the like without spattering or dripping. Thus, embodied methods to allow the consistent application of a substantially uniform layer of opaque material to an object.

Yet another object is to provide a coating spray including a composition that is premixed to a desired consistency for immediate, convenient use in applying the composition as an aerosol or spray to a dental implant.

Another object of the present invention is to provide a spray bonder that can be sprayed in an even and thin layer. In certain embodiments the bonder can be a titanium bonder. The bonder allows for, among other things, opaque to adhere to the surface of a dental implant.

One embodiment of the present invention is a dental implant spray system for coating dental implants. In some embodiments the coating spray component of the system comprises about 4 to about 50 wt % coating material, about 5 to about 60 wt % carrier, and about 10 to about 90 wt % non-CFC propellant. Other embodied spray compositions comprise coating materials that include opacious dentin or glaze (e.g., glass frit) in addition to or instead of an opaque material. For example, some embodiments of the present invention comprise about 4 to about 50 wt % opacious dentin, about 5 to about 60 wt % carrier, and about 10 to about 90 wt % non-CFC propellant, whereas some embodiments of the present invention comprise about 4 to about 50 wt % glass frit, about 5 to about 60 wt % carrier, and about 10 to about 90 wt % non-CFC propellant.

Another object of the present invention is to provide a spray bonder that is premixed to a desired consistency for immediate, convenient use in applying the composition to dental implant in an aerosol or spray composition.

Another object of the present invention is to provide a method of coating a dental implant comprising applying an embodiment of a coating spray system in accordance with the present invention. Some embodiments of methods for coating an object, such as a dental implant, comprise: providing a coating spray system, roughening a surface of the dental implant; spraying a spray bonder at least on to the abutment of a dental implant; firing the implant to set the bonder; spraying a coating spray at least on to the abutment of a dental implant; and firing the implant to set the coating material of the coating spray.

Another object of the present invention is to provide a system and method for coating metal objects, including titanium objects, with a glaze, opaque, opacious dentin, or the like.

These and other objects will be apparent from the present disclosure and claims. Additional substance, advantages and other novel features of the invention will be set forth in part in the description that follows and in part will become apparent to those skilled in the art upon inspection of the following or may be learned with practice of embodiments of the invention or improved development. Further, the above embodiments are examples of the present invention and not intended to be limiting thereof.

### BRIEF DESCRIPTION OF THE DRAWINGS

FIG. 1 shows a SEM image of the interface between a titanium surface (bottom) and a known coating composition (Vita TitanKeramik);

FIG. 2 shows a SEM image of the interface between a titanium surface (bottom) and a known coating composition (GC America);

FIG. 3 shows a SEM image of the interface between a titanium surface (bottom) and a known coating composition (Dentaurum);

FIG. 4 shows a SEM image of the interface between a titanium surface (bottom) and a coating made by a coating spray system in accordance with an embodiment of the present invention; and

FIG. 5 shows an enlarged view of the SEM image of FIG. 4.

### DESCRIPTION OF EXEMPLARY EMBODIMENTS

The details of one or more embodiments of the present invention are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Embodiments of the present invention include a coating spray system that comprises a spray bonder, a coating spray (e.g., spray opaque), or a combination thereof. Embodiments of coating spray systems can coat an object, including titanium objects, with a relatively thin, even coating. Embodiments of the present invention have the advantage of being able to provide such superior coatings in a timely and cost-effective manner. Embodiments of the present invention also do not require extensive training, and do not produce uneven or thick coatings.

In this regard, embodiments of coating spray systems can coat objects with a desired color. In some embodiments the coating spray system can coat a dental implant to reflect the color or pigment of a patient's gums. The term “reflect” is used herein to refer generally to the matching of the colors and shades of an implant with tissue a patient's mouth (e.g., gums) so that the implant is less visible or not visible when seen through a patient's gums. Dental implants that reflect the color of a patient's gums are not visible to the extent that uncoated or uncolored implants are because the implant more closely matches the colors and hues of the gums.

Embodiments of the present invention are not limited to coating any particular object. Some embodiments can be used to coat an object made of a material that opaque and other coating materials do not typically adhere, or to coat objects that require relatively thin and even coatings. For instance, dental implants require thin and even coatings so as to not unduly affected the fit, finish, or functionality of the implant. Further examples of objects to be coated include bars for dentures, copings, or balls located on implants and that are intended to hold dentures.

Embodiments of the present invention possess superior and unexpected advantages over prior system and methods. Known bonder compositions, which are not used for dental implants, typically comprise a bonder powder and a liquid. Known bonder require that one properly mix the bonder powder with the liquid to form a bonder mixture. Next, the bonder mixture is applied to an object with a brush. However, the mixing of the bonder powder and liquid is done manually, and therefore brush-on bonder mixtures frequently vary in bonder concentration and consistency. Bonder is also relatively expensive, and unused bonder or bonder that is left on a brush after an application can be raise operational costs significantly, possibly so that using a bonder is not an economically viable option. As described below, embodiments of the present coating spray system and spray bonder do not suffer from these deficiencies.

Furthermore, prior art aerosolized ceramic compositions typically included chlorofluorocarbons (CFCs). The CFCs were used as suspension agents and/or as propellants. Examples of CFCs include 1,1,1-trichloroethane and Freon TF 22 propellants. CFCs are now known to be hazardous. Inhalation or swallowing vapors may irritate the respiratory tract and affect the central nervous system. Over exposure symptoms include headache, dizziness, weakness, and nausea. Higher levels of exposure (>5000 ppm) can cause irregular heartbeat, liver, and kidney damage, fall in blood pressure, cardiovascular damage, unconsciousness and even death. 1,1,1-trichloroethane is also thought to be a carcinogen. Furthermore, CFC-containing substances are the source of several environmental problems, including the depletion of the ozone layer. Therefore, one advantage of embodiments of the present invention is that they can utilize non-CFC propellants.

Specific components, details, and methods for using embodiments of the present invention are described further below.

### Glass Frit

Glass frit is available from many different manufacturers worldwide. In embodiments of the present invention, the same glass frit currently used in the dental profession and hobby ceramist practicing the brush technique may be used in the formulation. Some particular embodiments utilize what is known in the art as titanium glass frit.

The glass frit may be in the form of either a natural or man-made mixture of inorganic chemical substances. The glass frit is produced by rapidly quenching a molten, complex amalgamation of materials. Such glass frit is available from a number of manufacturers under varying designations.

In embodiments, at least about 90% of the frit have a particle size of about 25 microns and under. In another embodiment, at least about 90% of the frit have a particle size of about 20 microns and under. In another embodiment, at least about 75% of the frit have a particle size of about 15 microns and under. In another embodiment, at least about 90% of the frit have a particle size of about 15 microns and under. In another embodiment, at least about 75% of the frit have a particle size of about 10 microns and under. In another embodiment, at least about 90% of the frit have a particle size of about 10 microns and under. Further, in embodiments of the present invention, at least about 75% of the frit have a particle size of about 8 microns and under. In another embodiment, at least about 90% of the frit have a particle size of about 8 microns and under.

Sources of glass frit are the Vita Zahnfabrik GmbH (Bad Sackingen, Germany), Ferro Corporation, Coating Division (Cleveland, Ohio), Ceragroup Industries, Inc. (Ft. Lauderdale, Fla.), and GC America, Inc. (Alsip, Ill.). 3227 leadless frit available from Ferro is an example of glass frit of the present invention. Another source includes Pentron Ceramics, Inc. (Somerset, N.J.). Further, the frit can be milled such as ball milled or jet milled in a ceramic mill to arrive at the preferred particle size.

In some embodiments the glass frit is wet-milled using. Wet milling can be performed by milling the glass frit particles in a liquid, such as an alcohol, for example. Wet milling has the advantage of smoothing the particles so that the particles work when sprayed through aerosol spray valves, for example.

In examples of the present invention, the glass frit is present in amounts ranging from about 4 to about 60 weight wt % of the total composition. In other examples, this glass frit is present in an amount of from about 8 to about 35 wt %. In other examples, this range is from about 9 to about 17 wt %. In some embodiments, as discussed below, the glass frit is a component of a coating material. In some embodiments a spray is a glaze, and the coating material in the coating spray consists only of glass frit.

Because of varying percentages of chemical components in the various glass frit formulations available from manufacturers, the intrinsic characteristics of the glass frit also vary. As a result, the particular weight percentages of the individual components of the glaze composition may need to be adjusted across the range set forth above to provide proper and consistent results.

### Coating Material

Embodiments of coating materials in accordance with the present invention can comprise glass frit, opacious dentin, an opaque (i.e., opaque material), or the like or combinations thereof. Some embodiments of coating materials comprise opaque materials, which include, but are not limited to, natural or man made oxides, leucite, and/or feldspar or feldspar mixtures. Coating materials are available from a number of different manufacturers under varying designations. The materials within the coating material are generally known, although the dimensions and other characteristics of the coating materials must be suitable for spray applications.

Examples of sources coating material include Ceramco, Inc. of Burlington, N.J., Dentsply, Inc. of York, Pa., Vident, Inc. of Brea, Calif., Vita Zahnfabrik, of Bad Sackingen, Germany, and GC America, of Alsip, Ill. Examples include Ceramco A-2 shade opaque and Vita A-2. Other coating materials include titanium ceramic shades A-1 and A-2, titanium opaque A-1 and A-2, and pink opaque modifier of GC America.

Because of varying percentages of, for example, man made and natural feldspar, leucite, and the like in the various coating material formulations available from these manufacturers, the intrinsic characteristics of the coating material also vary. As a result, the particular weight percentages of the individual components of the coating spray composition may, of course, need to be adjusted across the range as discussed above to provide proper and consistent results. In embodiments of the present invention, the coating material is present in an amount from about 4-50 wt %. Furthermore, in embodiments of the present invention, the coating material is present in an amount of from about 15-30 wt %. Additionally, in embodiments of the present invention, the coating material is present in amounts of from about 12-25 wt % (by weight %) of the total composition.

It is preferred that at least about 70 wt % of the coating material have a particle size of about 25 microns and under. In another embodiment, at least about 90 wt % of the coating material has a particle size of about 25 microns and under. In another embodiment, at least about 70 wt % of the coating material has a particle size of about 20 microns and under. In another embodiment, at least about 90 wt % of the coating material has a particle size of about 20 microns and under. In another embodiment, at least about 70 wt % of the coating material has a particle size of about 15 microns and under. In another embodiment, at least about 90 wt % of the coating material has a particle size of about 15 microns and under. In another embodiment, at least about 70 wt % of the coating material has a particle size of about 10 microns and under. In another embodiment, at least about 90 wt % of the coating material has a particle size of about 10 microns and under.

Known substances may be used in the coating material to impart a desired color to the coating material. In some embodiments the coating material will reflect the color of a patient's gums. Depending on the pigment of a patient's gums, this color can be calibrated by adjusting the levels of pink, red, blue, and other pigments in the coating material, for example.

In some embodiments the coating material is wet-milled, as described above.

### Carrier

The wetting agent, suspension agents, and/or carrier best suited for utilization in the spray bonder and coating spray include those that are currently used by the medical and dental industry. In some embodiments, the particle sizes of powders that comprise the coating material or the bonder are such that a separate suspending agent is not required, and the wetting agent (e.g., alcohol) can act as a suspending agent and vice versa. Furthermore, in some embodiments the wetting agent can serve as a carrier for the components in the composition, such as the coating material in a coating spray or the bonder in a spray bonder. Thus, the terms wetting agent, suspending agent, and carrier (hereinafter collectively “carrier”) are used interchangeably herein. Exemplary carriers do not react with other components of the compositions (e.g., coating spray, spray bonder) and can be fairly easy to volatize, yet do not represent a health, safety, or environment hazard during the spraying or drying of the composition.

An example of a carrier utilized in embodiments of the present invention is preferably an alcohol. A further example is a 99% anhydrous isopropyl alcohol that is standard in many home cleaners, air fresheners, etc., and medical aerosols used in hospitals and medical facilities. Other preferred alcohols include methyl, ethyl and isopropyl alcohol, or any mixtures thereof. In some embodiments use of an anhydrous alcohol is preferred. A carrier can be effective in maintaining solid substances in suspension so as to provide a smooth, even, and consistent spraying action without clogging, sticking or splattering.

Preferred carriers provide very good wetting action and are “water-free.” Therefore, for some embodiments there is no freezing of water droplets as the composition cools during spraying. This is a significant feature since freezing water droplets cause the formation of opaque platelets that lead directly to spotting and an inconsistent coating.

The carrier in embodied coating sprays and/or spray bonders can help provide desired characteristics for the respective spray compositions. Carriers can also help prevent insufficient wetting of an object, as well as spray orifice clogging, valve sticking and opaque spattering. Alternatively, a separate carrier may be used in the formulations of the present invention.

### Propellant

The propellant used in connection with the present invention can be a non-CFC propellant. Propellants can be flammable or inflammable. One propellant that may be used is a hydrocarbon propellant. Further more specific examples of propellants include isobutane, butane, propane, dimethyl ether, methyl ethyl ether, carbon dioxide, nitrous oxide, or combinations thereof. Some of the specific propellants discussed above, such as butane, are flammable. Nonflammable propellants also include Dymel™ 227ea/P propellant (DuPont; Wilmington, Del.), which comprises 1,1,1,2,3,3,3-heptafluoropropane (HFA-227), or HFO-1234ze (Honeywell, Morristown, N.J.), which comprises 1,3,3,3-tetrafluoropropene.

The butane and isobutane hydrocarbon propellants are available, for example, from Aeropres Corporation, Shreveport, La. under the designation of A-17, A-31 up to the strongest pressure of A-132 propellants. The non-CFC propellant of the present invention may be present in the composition in amounts ranging anywhere from about 10-90 wt %, about 30-90 wt %, and about 40-90 wt % by weight of the total composition.

In some embodiments spray pressures can range between about 17-132 psig. In some embodiments best results and the most consistent spray characteristics are obtained by packaging the compositions at a pressure in the range of between about 17-56 psig.

### Coating Spray

Embodiments of coating sprays comprise a coating material, a carrier, and, optionally, a propellant. In some embodiments the coating spray is housed in a container. To achieve the foregoing and other objects and in accordance with the purposes of the present invention as described herein, the coating spray composition can comprise, in weight, about 5 wt % to about 60 wt % coating material (e.g., opaque material), about 8 wt % to about 60 wt % carrier, and about 10 wt % to about 90 wt % non-CFC propellant. Other embodiments have about 40-75 wt % coating material, about 10 to about 40 wt % carrier, and about 40 to about 70 wt % propellant. Some embodiments of coating spray comprise about 10 to 30 wt % coating material, about 10 to 40 wt % carrier, and about 40 to 70 wt % non-CFC propellant.

In some embodiments, the coating spray comprises about 14 to 22 wt % coating material, about 28 to 36 wt % carrier, and about 44 to 56 wt % non-CFC propellant. In some embodiments the coating spray comprises about 21 to 28 wt % coating material, about 15 to 22 wt % carrier, and about 50 to 62 wt % non-CFC propellant.

Thus, some embodiments of sprays opaque comprise about 5 wt %, about 10 wt %, about 15 wt %, about 20 wt %, about 25 wt %, about 30 wt %, about 35 wt %, about 40 wt %, about 45 wt %, about 50 wt %, about 55 wt %, or about 60 wt % coating material. Some embodiments of sprays opaque comprise about 5 wt %, about 10 wt %, about 15 wt %, about 20 wt %, about 25 wt %, about 30 wt %, about 35 wt %, about 40 wt %, about 45 wt %, about 50 wt %, about 55 wt %, or about 60 wt % of a carrier. Furthermore, some embodiments of sprays opaque comprise about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or about 90 wt % propellant.

The coating spray composition can be sprayed on a dental implant or other object where it is desired to provide a coating of the coating material. In some embodiments the coating spray is sprayed on a surface that has already been coated with a bonder and has been fired. Furthermore, embodiments of coating spray are suitable for any other object that needs to be coated, including titanium copings and other metallic objects used in the dental as well as other industries.

In some embodiments of the present invention, the coating spray is delivered in a spray with an airbrush, mechanical spray bottle, and the like. In such embodiments, the pressure to spray the composition is supplied by an air compressor or the like. Thus, such embodiments do not require that the coating spray comprise a propellant, and can comprise a coating material and a carrier.

### Spray Bonder

To achieve the foregoing and other objects and in accordance with the purposes of the present invention as described herein, a spray bonder composition is provided. Embodiments of spray bonders comprise a bonder, a carrier, and, optionally, a propellant as described above. The bonder can be initially provided in powder form. Sources for the bonder powder include GC America, Inc., including their GC Initial Ti Bonder. In some embodiments a bonder is a glass frit having a thermal expansion that is about the same as the thermal expansion of the material the bonder can coat. For example, a titanium bonder comprises glass frit particles having a thermal expansion that equates to the thermal expansion of titanium metal. This characteristic of bonders can allow for good mechanical bond strength between the substrate (e.g., titanium) surface and the ceramic to be fired onto the substrate surface.

The bonder can be mixed with a carrier, such as isopropyl alcohol or the other carriers discussed above. Furthermore, should the spray bonder be provided in a can under pressure that can aerosolize the bonder, the spray bonder can further comprise a propellant, including any of the propellants discussed above. In this regard, the terms “bonder” can be used interchangeably with “spray bonder” when describing certain embodiments of the present invention.

In some embodiments the spray bonder is aerosolized with an airbrush or the like. In such embodiments, the spray bonder can be a mixture of bonder and carrier, and does not require a propellant since an air compressor or the like provides the spraying force. In such embodiments the spray bonder may comprise about 33 wt % bonder and about 66 wt % carrier. However, some embodiments may comprise about 20 wt % to about 40 wt % bonder, which may be in the form of a powder, and about 60 wt % to about 80 wt % carriers. Some embodiments may comprise about 10 wt %, about 15 wt %, about 20 wt %, about 25 wt %, about 30 wt %, about 35 wt %, about 40 wt %, about 45 wt %, or about 50 wt % bonder. Some embodiments may also comprise about 50 wt %, about 55 wt %, about 60 wt %, about 65 wt %, about 70 wt %, about 75 wt %, or about 80 wt % carrier.

In some embodiments, as discussed above, the spray bonder is provided in a pressurized container, and the spray bonder can be a mixture of bonder, carrier, and propellant. In such embodiments, the spray bonder can comprise about 2 wt % bonder, about 4 wt % carrier (e.g., alcohol), and about 94 wt % propellant. Further still, some embodiments can comprise about 0.1 wt % bonder, about 0.5 wt % bonder, about 1.0 wt % bonder, about 1.5 wt % bonder, about 2.0 wt % bonder, about 2.5 wt % bonder, about 3.0 wt % bonder, about 3.5 wt % bonder, or about 4.0 wt % bonder. Some embodiments can comprise about 1.0 wt % carrier, about 1.5 wt % carrier, about 2.0 wt % carrier, about 2.5 wt % carrier, about 3.0 wt % carrier, about 3.5 wt % carrier, about 4.0 wt % carrier, about 4.5 wt % carrier, about 5.0 wt % carrier, about 5.5 wt % carrier, about 6.0 wt % carrier, about 6.5 wt % carrier, or about 7.0 wt % carrier. Some embodiments can comprise about 89 wt % propellant, about 90 wt % propellant, about 91 wt % propellant, about 92 wt % propellant, about 93 wt % propellant, about 94 wt % propellant, about 95 wt % propellant, about 96 wt % propellant, about 97 wt % propellant, about 98 wt % propellant, or about 99 wt % propellant. Specific embodiments comprise about 0.5 grams of bonder, 1.0 grams of carrier, and 25 grams of propellant in a container, which equates to about 1.9 wt % bonder, 3.8 wt % carrier, and about 94.3 wt % propellant.

### Coating Spray System and Methods

As stated above, embodiments of the present invention include a coating spray system that can be used to coat objects. In some embodiments the coating spray system can be utilized to coat a dental implant, including an abutment thereof, so that it reflects the pigment of a patient's gums. The coating spray system may also be used on dental restorations or other objects that need to be coated with a coating material.

In a first step a spray bonder can be applied to an object. If the object being coated is a dental implant, it is preferable that at least the abutment be coated with the bonder. In this regard, the term “apply” is used herein to refer to any method for applying a substance, such as a spray bonder or coating spray, on to an object. In some embodiments apply means that a substance is sprayed so that it is deposited on a surface of an object. In specific embodiments applying can mean spraying an aerosolized substances or spraying by way of an airbrush or the like.

Next, the object coated with the bonder is fired. In this regard, the term “fire” or “firing” is used herein to describe any process for setting, curing, or hardening a substance on to the surface of an object. In some embodiments, firing comprises heating the objected coated with a substance at about 450° C. to about 810° C. so that the substance hardens and adheres to the surface of the object. For objects that are made of commercially pure titanium, the bonder can be a titanium bonder. Dental implants are an example of objects that typically are made either partially or exclusively with titanium. Other objects that can be coated can comprise chrome cobalt and other dental alloys or ceramic materials, and at least the spray bonder can be appropriately modified according to the material to be coated.

Through this method of applying and firing a spray bonder, a thin, even coat of bonder can be applied to the object in a short amount of time by one having little to no experience. More specifically, spraying, rather than brushing, the bonder coatings makes it relatively easy to produce coatings that are less than about 0.5 mm thick and that do not have pools or brush streaks. This is advantageous for the fit and finish of any object, and particularly so for dental implants that have to fit within relatively tight spaces.

Then, a coating spray can be applied over the bonder. For dental implants the coating spray can be applied at least to the abutment that potentially will be visible through a patient's gums. After the coating spray has been applied, the object can be fired so that the coating material sets on the dental implant. Again, in some embodiments the firing temperature can be about 450° C. to about 810° C.

Optionally, one or more additional coats of coating material can be applied. In some embodiments the object is re-fired after each successive coat is applied. Furthermore, in some embodiments, after applying one or more coats of coating material to the object, one or more coats of coating spray comprising, partially or wholly, glass frit are applied on to the object. For example, in an exemplary embodiment a coating spray comprising a colored opaque material is first applied and fired on to an object, and then a coating spray comprising only glass frit is applied and fired on the object. The glass frit in the later coating(s) can provide a glazed finish on the object's surface. This can be advantageous for dental applications, since colored spray coatings (e.g., opaque coatings) can have a rough texture that can potentially block plaque and other bacteria, but subsequent glaze coating(s) can smoothen the surface of the dental object in order to prevent the accumulation of plaque and other bacteria on the coating's rough surface.

In some embodiments the object to be coated is roughened before applying the spray bonder. Roughening can be accomplished by any known method, including by sandblasting. In some embodiments roughening comprises sandblasting an object with aluminum oxide particles. In specific embodiments sandblasting is carried out by delivering aluminum oxide particles having a size of less than 120 to 150 microns at 45 degrees relative to the object to be roughed at about 30 to 35 psi. Furthermore, in some embodiments, after roughening the surface, the surface is exposed to the atmosphere or the like and is allowed to oxidize. For example, for titanium surfaces, the titanium is exposed to air for about 5 minutes to about 15 minutes to allow for oxide growth on the titanium surface.

In some embodiments the spray bonder and/or coating spray is contained in a container that is capable of aerosolizing the spray bonder. In some embodiments aerosolization achieved by a propellant housed under pressure within the container. In some embodiments the spray bonder and/or opaque are aerosolized by an airbrush or the like. Typically, waste is most reduced the substance is delivered as an aerosol from a pressurized container, since spray intensity and duration can be tightly controlled. On the other hand, application with a brush is wasteful since the resulting layer can be thicker than necessary and unused materials can remain on the brush. Even application with an airbrush is relatively uncontrolled and can result in materials being wasted. This is a particular concern for spray bonder, since the bonder itself is typically very expensive relative to the other components used in a method for making a coating.

In some embodiments the spray bonder and coating spray are premixed within a container, so that it is not necessary to mix the bonder powder and/or coating material with a respective carriers before applying the components to an object. Those of skill in the art will appreciate that this ready to apply and relatively simple system can further reduce the skill and time needed to apply an coating, such as a colored coating, on to a surface. A combined and premixed spray bonder and/or coating spray also can reduce the amount of variance between different coating, since virtually all human and measurement error is eliminated.

The coating spray can be of any color, and the color can be dictated by the color of the coating material in the coating spray. Preferably the coating spray is of a color that reflects the color of a patient's gums. In some embodiments, a plurality of different colored coating sprays and/or a coating spray having a plurality of differently colored coating materials are applied to a dental implant in order to have the dental implant reflect the color of a patient's gums. In specific embodiments the coating spray has a color that matches the natural color of a subject's teeth, tooth root, or tissue, optionally in varying shades of pink and blue to match tissue of different ethnic groups.

### EXAMPLES

Embodiments of the present invention are further illustrated by the following specific but non-limiting examples. The examples may include information representative of information gathered at various times during the course of development and experimentation related to the present invention.

### Example 1

This Example is a spray glaze composition. 17 grams of Ceragroup Industries, Inc. leadless glass frit is milled until about 90% or more of the particles have a particle size of less that 25 microns, and is added to 34 grams of 99% anhydrous isopropyl alcohol in an aluminum 45 mm×165 mm lined aerosol spray can container manufactured by Amber International, Denville, N.J. The container is supplied with an internal mixing ball. 60 grams of A-31 propellant is added to the contents of the aerosol spray container. All the materials are thoroughly mixed and the spray container crimped and sealed. More specifically, this provides the aerosolized spray glaze with a pressure of about 31 psig at 70 degrees Fahrenheit.

The aerosol spray container is equipped with a spray valve assembly available from Summit Valve and Controls, Inc. of Edmonton, AB, Canada. Specifically, the assembly comprises a stem (Part No. 920103), a SV-Body (Part No. 9/77311), a spring (Part No. 77401), a gasket buna (Part No. 77505), a M. CUP EPT (Part No. 9/77792), a black mark (Part No. 190C24), and a tube (Part No. 200610/200000).

### Example 2

This is an example of a coating spray composition. 30 grams of dental opaque furnished by CeraGroup, of Delray Beach, Fla. is added to 23 grams of 99% anhydrous isopropyl alcohol in an aluminum 53 mm×165 mm lined aerosol spray container manufactured by Amber International. These materials are thoroughly mixed and the spray container crimped and sealed. The container is supplied with an internal mixing ball. The container is then charged with 60 grams of A-31 propellant. This provides the aerosolized spray glaze with a pressure of about 31 psig at 70 degrees Fahrenheit.

The aerosol spray container is equipped with a spray valve assembly available from Summit Valve and Controls, Inc. of Edmonton, AB, Canada. Specifically, the assembly comprises a stem (Part No. 920103), a SV-Body (Part No. 9/77311), a spring (Part No. 77401), a gasket buna (Part No. 77505), a M. CUP EPT (Part No. 9/77792), a black mark (Part No. 190C24), and a tube (Part No. 200610/200000).

### Example 3

This Example is of a spray bonder composition. Briefly, 0.5 g of GC Initial Ti Bonder (GC America, Inc.) and 1.0 g of anhydrous isopropyl alcohol and placed in an aluminum 202×214 lined aerosol spray container manufactured by CCL Container Corporation, Hermitage, Pa. These materials are thoroughly mixed and the spray container crimped and sealed. The container is supplied with an internal mixing ball. 25 grams of A-31 propellant are then charged into the container.

The aerosol spray container is equipped with a spray valve assembly available from Summit Valve and Controls, Inc. of Edmonton, AB, Canada. Specifically, the assembly comprises a stem (Part No. 77258), a SV-Body (Part No. 9/77311), a spring (Part No. 77401), a gasket buna (Part No. 77505), a M. CUP EPT (Part No. 9/77792), a black mark (Part No. 190C24), and a tube (Part No. 200610/200000).

### Example 4

This is an example of an opaque application procedure. A titanium dental implant restoration is provided by Straumann USA LLC of Andover, Mass. The abutment of the dental implant is subjected to sandblasting using aluminum oxide particles having a particle size of no smaller than about 120 and no larger than about 150 microns at about 30 psi and 45 degrees relative to the implant. The surface is given a passivating time of about 30 minutes.

Thereafter, a very thin coating of the spray bonder discussed in Example 3 is applied to the abutment. The container is kept at about 1 to about 4 inches from the abutment and the spray bonder is applied in small bursts so as to minimize unnecessary waste of the spray bonder. The bonder is then fired at a preheated temperature of 450° C. with a temperature rise of 55° C./min under vacuum to a final temperature of 810° C. There is a drying time of about 4 minutes and a holding time of about 1 minute.

Next, the coating spray of example 4 is applied in the same manner as the spray bonder on the dental implant that now has the fired bonder. The coating spray coating is fired under the same conditions as the spray bonder. Subsequently, one or more additional coats of opaque may be sprayed and fired until the dental implant acquires the desired appearance. Notably, this same procedure can be used to coat any other desired object, including any titanium objects.

### Example 5

This Example describes tests performed on titanium surfaces coated with embodiments of the coating spray system. The tests characterize the physical characteristics of the coatings, and compare them to conventional coatings known in the art. The results show that the present coating spray system produces superior and expected results when compared to known bonder/coating systems.

The bond strength test was evaluated using methods as described in ISO standard 9693 and draft standard on ceramic compatibility. A total of 15 specimens for each group were tested for bond strength by using the Schwickerath crack initiation test (ISO 9693). The titanium specimens were (25±1) mm×(3±0.1) mm×(0.5±0.05) mm. The titanium specimens were treated with known coating systems according to the respective manufacturers' instructions (i.e., Vita Titankeramik by Vita Zahnfabrik; GC America; and Dentaurum) for porcelain bonding/veneer as well as with the present coating spray system, which comprised an aerosolized spray bonder and an aerosolized coating spray.

Specifically, and per the known method's instructions, opaque ceramic was applied over a length of (8±0.1) mm symmetrically on one 3 mm wide side of each specimen. The body ceramic was applied to each specimen to form a total ceramic thickness of (1.1±0.1) mm after firing. The ceramic layer had a rectangular shape. Each specimen was submitted to a glaze firing in accordance with the known manufacturer's instructions.

The fired specimens were then placed in the three point bending apparatus (distance between supports: 20 mm; radius of the bending piston: 1 mm) with the ceramic positioned symmetrically on the side opposite to the applied load. The force was applied at a constant rate of (1.5±0.5) mm/min using an Instron universal testing machine and recorded up to failure. The fracture force F (failure load) (in newtons) for each of the six specimens was measured for specimens failing by a debonding crack occurring at one end of the ceramic layer. The fracture force F (failure load) was multiplied by a coefficient k, which was obtained from a graph in the standard. The coefficient k was a function of the thickness of the metal substrate dM (0.5±0.05) mm, and the value of Young's modulus EM according to ISO 22674 of the metal bar material.

More specifically, the debonding/crack-initiation strength T b was calculated using the equation:

Tb=k×F

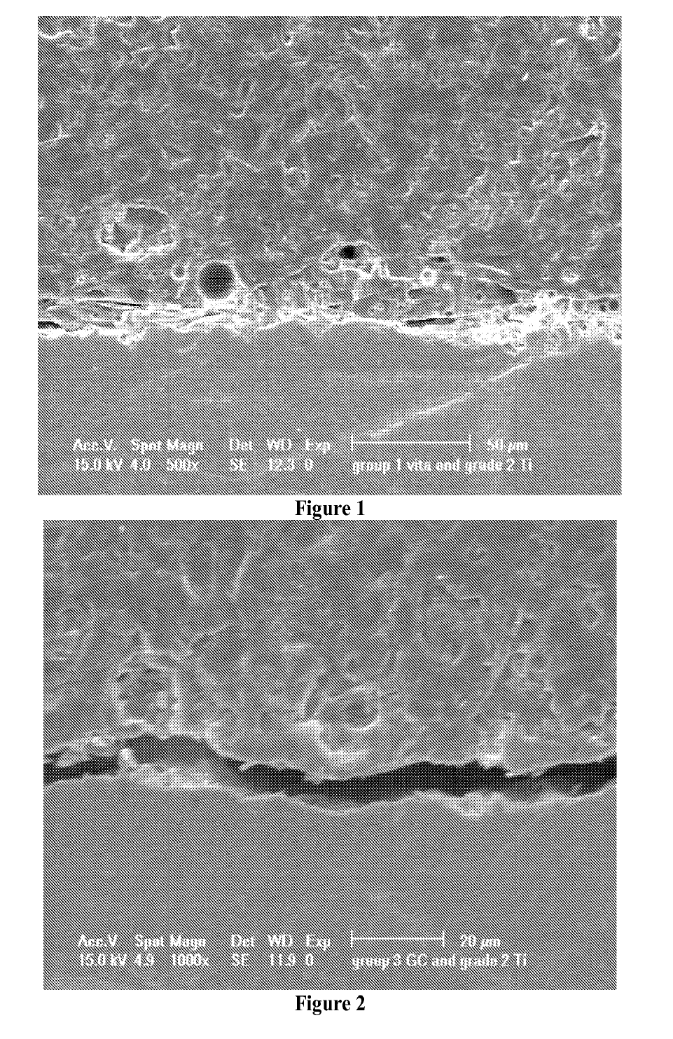

The bond interface was further evaluated using a Scanning Electron Microscope (SEM). FIGS. 1-5 demonstrate the improved adaptation and lack of porosity of the coatings produced by the present coating spray system as opposed to the other known coating systems. Please note that in FIGS. 1-5, the titanium is located on the bottom of the figure. Thus, FIGS. 1-5 make clear that the present coating spray system produces coatings that are superior when compared to known systems and methods.

The bond strength data for the coatings made with the present coating spray system compared to those made by known systems and methods are shown in Table 1.

TABLE 1
Schwickerath Bond Test

| | Manufacturer's | Present |
|---|---|---|
| Veneer Material | Bonder/Opaque | Bonder/Opaque |
| Vita Titankeramik | 22.3 ± 8.5 | 29.0 ± 6.0 |
| GC | 16.6 ± 9.9 | 17.9 ± 4.0 |
| Dentaurum | 10.0 ± 6.9 | 18.3 ± 2.3 |

The data was analyzed statistically using ANOVA and Tukey at p<0.5 with JMP8.0 software. The present coating spray system are significantly higher than the Vita and Dentaurum coating groups. Failure analysis showed defects in bonding of the opaque/bonder to the titanium for all currently known opaque/bonder systems, but not in the present bonder/opaque coating spray system in accordance with an embodiment of the present invention.

An additional test involved load to failure testing of veneered porcelain on titanium molar copings to produce crowns with approximately 1.5 mm thickness of porcelain. A silicone mold was created of a fired crown and porcelain was vibrated into the mold containing the coping. The porcelain was fired according to the known manufacturer's recommendations. Five specimens were used for each group, one being the opaque/bonder coating spray system in accordance with an embodiment of the present invention, and the other being Vita Titankeramik opaque/bonder. These were then bonded to epoxy dies using Ivoclar multilink implant cement and loaded on the cusps using a stainless steel ball on top of a layer of tin foil to distribute stress. They were loaded using the Instron at a crosshead speed of 0.5 mm/min until fracture. The maximum load to failure of the restorations are reported in Table 2.

TABLE 2
Load to Failure Test

| Bonder/Opaque Material | Load To Failure (N) |
|---|---|
| Vita | 872.5 ± 172.7 |
| Enamelite | 928 ± 167.9 |

Statistical analysis revealed that the load to failure was equivalent due to failure of the porcelain.

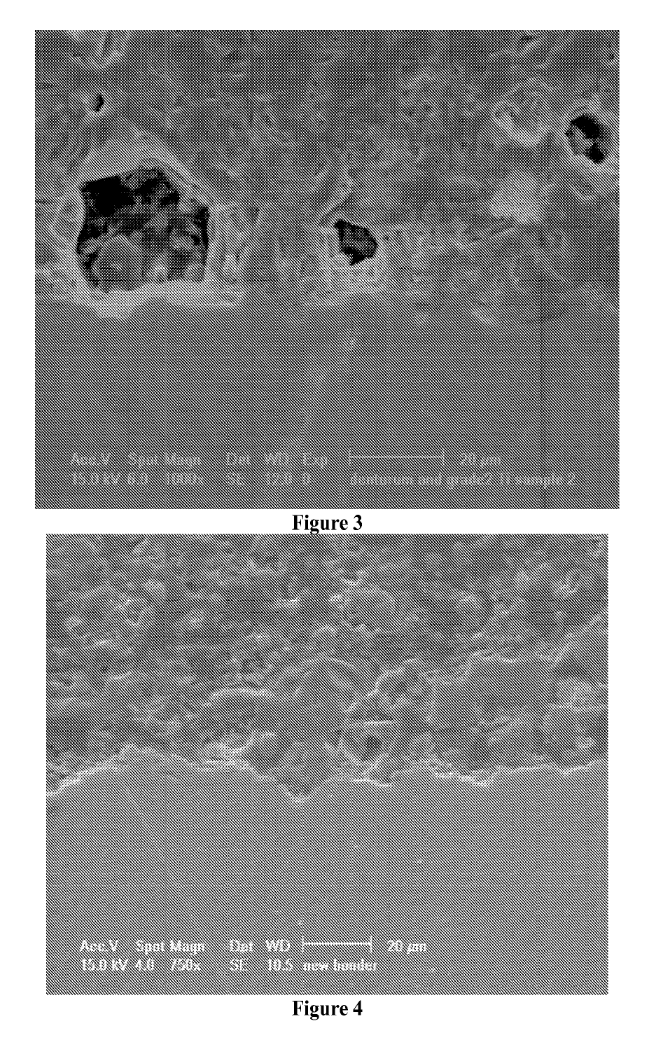

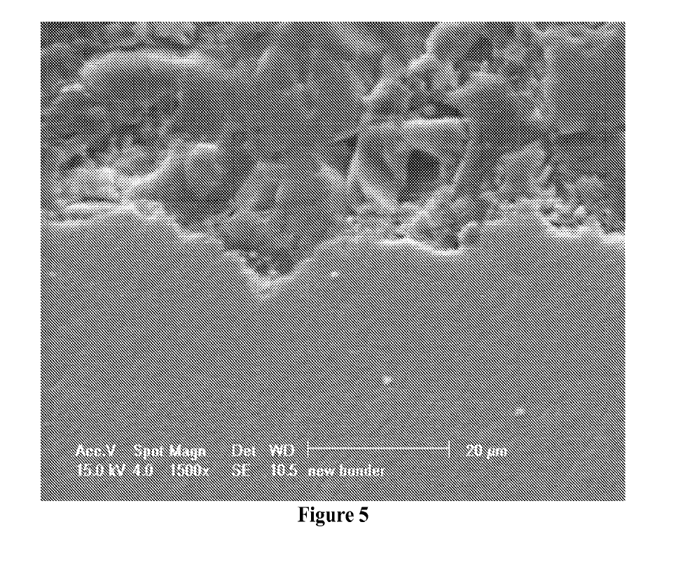

Accordingly, these and other data show that the present coating spray system produces superior and unexpected results in terms of at least bond strength when compared to other known systems and methods. Furthermore, examination of the interface between the titanium and the opaque/bonder revealed a substantially or completely pore-free, well-attached layer (FIGS. 4-5). On the other hand, the other known materials that were examined exhibited numerous pores and area of delamination (FIGS. 1-3).

In summary, numerous benefits will result from employing the concepts of the present invention. The compositions, systems, kits, and methods described herein are very expedient in their application, requiring minimal experience or skill to apply an even uniform layer of a coating material to an object, such as a titanium dental implant. Some embodiments have the superior advantage of resolving gum coloration issues that are caused by dark colored abutments on dental implants.

The invention thus being described, it would be obvious that the same may be varied in many ways. Such variations should not be regarded as a departure from the spirit and scope of the present invention, and all such variations as would be obvious to one of ordinary skill in the art are intended to be included within the scope of the following claims.

This application references various patents and/or publications. All such patents and/or publications are expressly incorporated herein by reference in their entirely.

Following long-standing patent law convention, the terms “a”, “an”, and “the” refer to “one or more” when used in this application, including the claims. Thus, for example, reference to “a composition” includes a plurality of such compositions, and so forth.

Unless otherwise indicated, all numbers expressing quantities of ingredients and so forth as used in the specification and claims are to be understood as being modified by the term “about.” Accordingly, unless specifically indicated to the contrary, the numerical parameters set forth in this specification and claims are approximations that may vary depending on the desired properties sought to be obtained by the present invention.

In this regard, the term “about” as used herein when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

1. A coating spray system, comprising:
a coating spray that includes a coating material, a first propellant, and a first carrier; and
a spray bonder that includes a bonder, a second propellant, and a second carrier.

2-3. (canceled)

4. The coating spray system of claim 1, wherein the first propellant, the second propellant, or both are a non-CFC propellant.

5. The coating spray system of claim 1, wherein the first propellant, the second propellant, or both are selected from the group consisting of butane, isobutene, propane, or combinations thereof.

6. The coating spray system of claim 1, wherein the first carrier, the second carrier, or both are selected from the group consisting of methyl alcohol, ethyl alcohol, isopropyl alcohol, anhydrous isopropyl alcohol, or combinations thereof.

7. The coating spray system of claim 1, wherein the coating material includes an opaque material, glass frit, opacious dentin, or a combination thereof.

8. The coating spray system of claim 1, wherein the coating spray comprises about 5 wt % to about 60 wt % of the coating material.

9. The coating spray system of claim 1, wherein the coating spray comprises about 5 wt % to about 60 wt % of the first carrier.

10. The coating spray system of claim 1, wherein the coating spray comprises about 10 wt % to about 90 wt % of the first propellant.

11. The coating spray system of claim 1, wherein the spray bonder comprises about 1 wt % to about 80 wt % of the second carrier.

12. The coating spray system of claim 1, wherein the spray bonder comprises about 0.1 wt % to about 50 wt % of the bonder.

13. The coating spray system of claim 1, wherein the spray bonder comprises about 10 wt % to about 90 wt % of the second propellant.

14. The coating spray system of claim 1, wherein the first carrier is the same as the second carrier.

15. The coating spray system of claim 1, wherein the first propellant is the same as the second propellant.

16. The coating spray system of claim 1, wherein the coating spray is housed in a container under pressure.

17. The coating spray system of claim 1, wherein the spray bonder is housed in a container under pressure.

18. A spray bonder, comprising:
a bonder,
a carrier, and
a propellant.

19. (canceled)

20. The spray bonder of claim 18, wherein the propellant is selected from the group consisting of butane, isobutene, propane, or combinations thereof.

21. The spray bonder of any of claim 18, wherein the carrier is selected from the group consisting of methyl alcohol, ethyl alcohol, isopropyl alcohol, anhydrous isopropyl alcohol, or combinations thereof.

22. The spray bonder of claim 18, comprising about 0.1 wt % to about 50 wt % of the bonder, about 1 wt % to about 80 wt % of the carrier, and about 10 wt % to about 90 wt % of the propellant.

23-24. (canceled)

25. The spray bonder of claim 18, wherein the spray bonder is housed in a container under pressure.

26. A method for coating an object, comprising:
applying a spray bonder to the object, the spray bonder including a bonder, a second carrier, and a second propellant;
applying a coating spray to the object after applying the spray bonder, the coating spray including a coating material, a first carrier, and a first propellant; and
firing the object after applying the coating spray.

27. The method of claim 26, further comprising firing the object after the step of applying the spray bonder and before the step of applying the coating spray.

28. The method of claim 26, wherein the object comprises titanium.

29. The method of claim 26, wherein the object includes a dental device and/or a dental implant.

30-46. (canceled)
